(19) United States
(12) Patent Application Publication
(10) Pub. No.: US 2026/0252534 A1
(43) Pub. Date: Aug. 27, 2026

(54) SEMANTIC FILE PLACEHOLDERS

(71) Applicant: MICROSOFT TECHNOLOGY LICENSING, LLC, Redmond, WA (US)

(72) Inventor: Hardik Rajiv SHAH, Seattle, WA (US)

(21) Appl. No.: 19/064,518

(22) Filed: Feb. 26, 2025

(51) Int. Cl. G06F 16/178; G06F 16/16; G06F 16/182

(52) U.S. Cl. CPC G06F 16/178; G06F 16/162; G06F 16/182

(57) ABSTRACT

Information is received that indicates files that are associated with a context of a user's activity. Based on the information, a temporary placeholder folder and placeholder files corresponding to the files are generated. The temporary placeholder folder and placeholder files are rendered on a user interface indicating the placeholder folder and placeholder files as folders and files within a file system running on the device. The placeholder files are not hydrated on the device. A mapping of the placeholder files to underlying files represented by the placeholder files is maintained.

### BACKGROUND

Computing systems have built-in file management applications that enable users to navigate, organize, and manage files and folders. A graphical user interface (GUI) is typically provided to access local storage as well as cloud storage (e.g., OneDrive). Such cloud-based service providers typically provide file hosting and file synchronization platforms that synchronize the cloud platform with folders on a local drive on the client device. Users can add new files or folders at the client device, and the new files or folders are uploaded to the cloud platform or created at the cloud platform. It is with respect to these and other considerations that the disclosure made herein is presented.

### SUMMARY

Traditional file placeholders in cloud-based systems represent specific files in a well-defined hierarchy. For example, there is typically a 1-to-1 mapping of files on disk to files on the cloud platform. In response to opening a selected file, that file is hydrated (data is downloaded into that file) from the cloud platform. Users can be provided the option to dehydrate the file to save space locally. However, users lack flexibility in dynamically reflecting semantic groupings, such as time-based collections, tags, or projects. Current systems also do not integrate external application programming interfaces (APIs) to automatically generate contextual placeholders.

The present disclosure describes techniques for implementing semantic file placeholders within a file system for cloud-based systems. In an embodiment, the semantic file placeholders represent dynamically generated file or folder topics, such as “Today's Files” or “Project X Documents.” In some embodiments, the topics can be determined from information provided via web APIs or metadata. In response to user interaction with files or folders in semantic file placeholders, a file system filter driver intercepts access commands and resolves placeholders by retrieving the corresponding data dynamically from the cloud or local cache, ensuring efficient and intuitive access to contextually relevant files. Unlike traditional placeholders, semantic file placeholders are not bound to static file paths.

The embodiments disclosed herein can increase the reliability and performance of cloud-based productivity platforms by enabling efficient and timely presentation of relevant files and folders, and mitigate data loss, data corruption, or unpredictable application behavior when the user cannot efficiently to access the desired data. More efficient and timely processes for file/folder structures, in turn, result in better performing computing devices that utilize fewer processor cycles, less memory, and less power. Other technical benefits not specifically mentioned herein can also be realized through implementations of the disclosed subject matter.

These and various other features will be apparent from a reading of the following Detailed Description and a review of the associated drawings. This Summary is provided to introduce a selection of concepts in a simplified form that are further described below in the Detailed Description. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, same reference numbers in different figures indicate similar or identical items.

FIG. 1A illustrates an example architecture in accordance with the present disclosure.

FIG. 1B illustrates an example architecture in accordance with the present disclosure.

FIG. 2 illustrates an example architecture in accordance with the present disclosure.

FIG. 3 illustrates an example procedure in accordance with the present disclosure.

FIG. 4 illustrates an example architecture in accordance with the present disclosure.

### DETAILED DESCRIPTION

The following Detailed Description describes technologies for implementing semantic file placeholders in a file system. The semantic file placeholders can be implemented in various environments including individual systems, distribution systems, cloud-based systems, and the like. The semantic file placeholders represent dynamically generated file or folder topics, such as “Today's Files” or “Project X Documents.” In some embodiments, the topics are determined based on a context of a user's computing activity. Such contextual information can be provided from APIs or metadata.

In response to user interaction with files or folders in semantic file placeholders, a file system filter driver intercepts access commands and resolves placeholders by retrieving the corresponding data dynamically from the cloud or local cache, enabling efficient and intuitive access to contextually relevant files.

Unlike traditional file system placeholders, the disclosed semantic file placeholders are not bound to static file paths. In an embodiment, the creation of semantic placeholders includes, for example, a cloud provider/cloud system (e.g., Microsoft OneDrive) triggering a timer or event-based mechanism to initiate a process to obtain contextual information. For example, a periodic API call can be made to a service to retrieve contextual information (e.g., “Today's Files”). In some embodiments, contextual information may be obtained locally. Based on the contextual information, file and folder placeholders are created using metadata and represented as special file system entries with unique identifiers and names based on contextual data (e.g., “ProjectX”). The created file placeholder can be named based on an analysis of the contextual information. The selection of the files included in the semantic file placeholder can be based on a threshold indicative of relevance to the contextual information. For example, a scoring algorithm can be implemented that scores relevance based on content of a file or use of the file by users that are identified as being associated with a project.

In an embodiment, the unique identifiers can be implemented using reparse tags. As used herein, a reparse tag is an identifier in a file system that is used to mark files or directories with reparse points. Reparse points allow additional processing by the file system or other applications. A reparse point can be implemented as metadata structures in some examples.

In an embodiment, the user is provided a way to navigate to the location represented by the file and folder placeholders, such as “C:\OneDrive\SemanticPlaceholders\ProjectX” using a file management application such as File Explorer. The file system of the operating system (OS) recognizes the path as a reparse point or tag data and invokes a file system filter driver configured to handle the associated tag. The file system filter driver intercepts the navigation attempt and processes the reparse metadata. The file system filter driver can be implemented between the user interface and the underlying file system, in some implementations.

In an embodiment, the file system filter driver reads the reparse tag and identifies the placeholder as a semantic placeholder. The file system filter driver forwards the metadata (e.g., query: “ProjectX files”) to the cloud provider or a helper service. The cloud provider or helper service accesses or fetches the actual content corresponding to the placeholder (for example from cache, via an API, or via a file retrieval service). For example, the cloud provider or helper service can fetch “all files relevant to ProjectX” or “today's relevant files.”

In an embodiment, the placeholder files can be identified using artificial intelligence/machine learning (AI/ML) techniques. In some embodiments, an algorithm or process can be implemented to identify placeholder files. In an embodiment, a temporary directory is created (e.g., C:\OneDrive\Temp\ProjectX) and populated with links or placeholders for the resolved files. The callback is returned to the file system filter driver.

In an embodiment, the file system filter driver updates the reparse point's redirection target dynamically. The file system filter driver handles requests targeting the original reparse point path and internally forwards the requests to the temporary directory.

In an embodiment, once redirected, the user can automatically navigate into the temporary directory. The temporary directory can be any directory that the file system can keep track of. One example in the Windows context is “C:\OneDrive\Temp\ProjectX.” The user is presented with resolved files and folders. Hydration of a file is triggered when the user selects or clicks on a selected file and a file open request is generated. The file system filter driver intercepts the file open request, and the file is downloaded if the file is not already local.

In an embodiment, temporary directories are periodically cleaned to avoid clutter. Files in the temporary directories may become stale or otherwise fall out of use, for example if a project is complete and the placeholder folder and files are no longer in active use by the user. In one embodiment, if the placeholder folder and files have not been accessed for a threshold time period, the placeholder folder and files can be removed and no longer visible to the user. Since the underlying files are still stored in their original locations, there is no actual deletion of data.

In some embodiments, the user can be provided with a notification that a semantic file folder has been generated and is available for use. For example, a pop-up notification may be provided when the user logs into their device, informing the user that a “ProjectX” folder has been generated based on recent user activity. The user may further be provided the link or location information, and an option to delete the semantic file folder if the folder is not desired.

In some embodiments, the disclosed semantic file folder feature can be a configurable option for the user. In one embodiment, the user can be provided the option to only generate semantic file folders for selected contexts, such as files associated with a given project or organization, or for a specified time period. Various levels of granularity can be provided for the user to specify when the semantic file folder feature should be invoked. Optionally, the user can be provided the option to convert the semantic file folder to a permanent folder. In some embodiments, the user can select settings including whether to generate the temporary placeholder folder and placeholder files, when to generate the temporary placeholder folder and placeholder files, and how long to maintain the temporary placeholder folder and placeholder files.

The disclosed technologies enhance user productivity by providing dynamic, context-sensitive file organization and access, eliminating the need for manual search and categorization of files and folders. The disclosed technologies minimize resource usage by only hydrating files when explicitly accessed, optimizing storage and bandwidth. By leveraging API integration, the disclosed technologies provide adaptation and scalability to diverse scenarios, such as time-sensitive tasks or project-specific workflows.

Existing solutions such as traditional placeholders or files on demand represent specific files or folders within a static hierarchy of the cloud storage system. Such traditional placeholders or files rely on predefined structures, requiring users to know exact file paths or manually navigate in order to locate content. While traditional placeholders or files optimize storage and bandwidth by downloading files on demand, they are rigid in organization and cannot represent non-linear or dynamic groupings such as “Files Modified Today” or “Tagged Documents.” Semantic placeholders represent virtual collections of files based on context-driven queries or user intent. Unlike files on demand, these placeholders dynamically adapt to changing metadata or external API results. For example, a placeholder titled “Project X” might dynamically display all files tagged with “Project X” regardless of their actual storage location in the cloud. Additionally, these placeholders provide seamless user navigation by dynamically resolving and materializing relevant data into temporary folders.

The disclosed semantic placeholders provide flexibility by adapting to changing metadata, making them suitable for time-sensitive or project-oriented workflows. The disclosed semantic placeholders leverage external APIs to create intelligent, context-sensitive groupings that are not possible with static placeholders. Additionally, the disclosed semantic placeholders enable file access based on semantics rather than a rigid folder structure, improving user productivity. Similar to files on demand, semantic placeholders hydrate files only when accessed, but their dynamic nature reduces unnecessary navigation and improves access efficiency.

Some file hosting platforms allow for files to be stored at the client device solely as metadata until the user attempts to access the files. The metadata enables display information for a particular file that shows the file type, file size, title, and any other suitable information for storing as metadata. When a user selects the particular file for opening, reading, or writing, the file content data for the particular file is automatically downloaded to the client device. As described herein, the term “dehydrated file” refers to a data file that is stored on a local drive of a client device in a format that makes the data file visible to a user in a file-browser GUI while at least some content data of the data file is absent from the local drive. For example, a dehydrated file may be a relatively small file that is stored locally on a client device to represent a hydrated counterpart file that is stored in a cloud database. An example dehydrated file may include a thumbnail image (e.g., a reduced-size visual representation of file content data) and metadata that identifies the name of the file and points to its hydrated counterpart in the cloud. More generally, we can define a dehydrated file as any file that has metadata but does not have the entire content on disk. Accordingly, hydration is the act of retrieving any content not already on disk by downloading it from the cloud.

As described above, the term “hydrated file” may refer to a data file for which both metadata and file content data are stored on a local drive of a client device so that the data file can be opened locally without fetching the file content data from a cloud database.

In a more general embodiment, a dehydrated file may be defined as any file that has metadata but does not have the entire content on disk. Hydration, then, is the act of retrieving any content not already on disk by downloading it from the cloud.

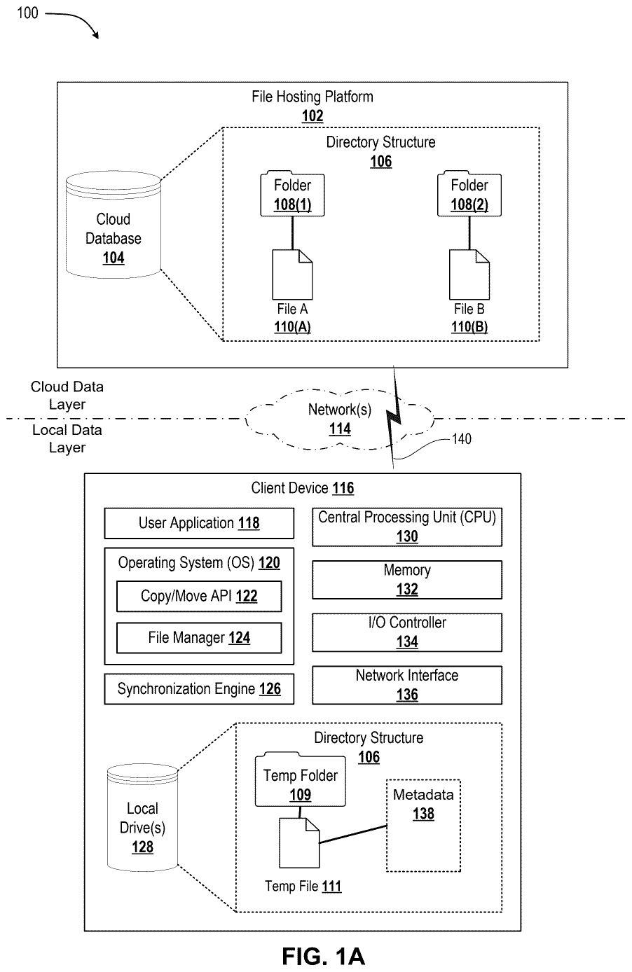

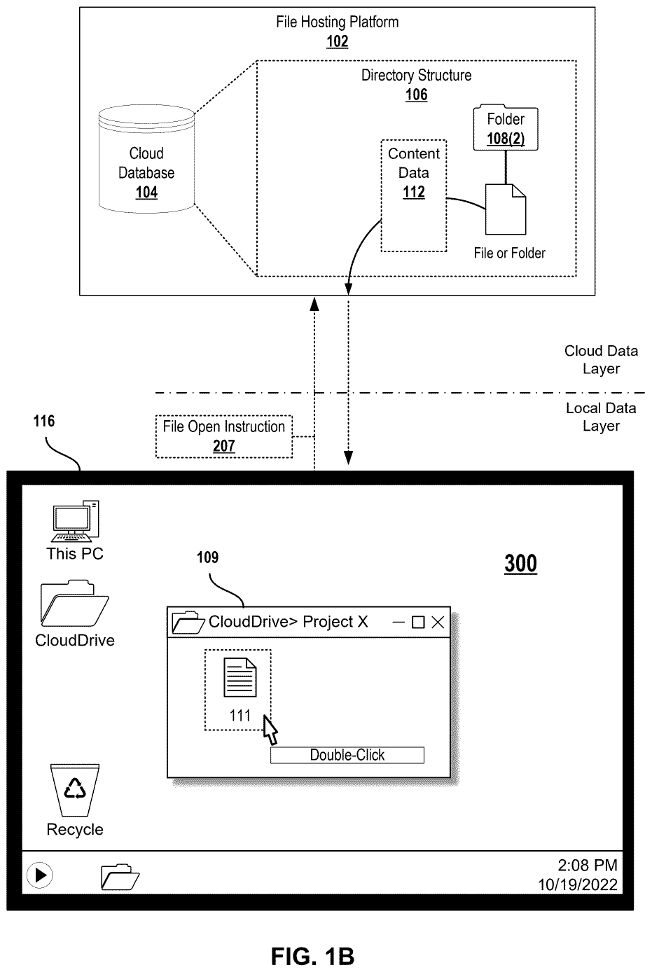

Referring to FIG. 1A, illustrated is an example system 100 including a client device 116 and a file hosting platform 102 configured to maintain copies of files in a cloud database 104. The client device 116 may have a file I/O manager. Users may perform an operation on a temporary file 111 of a temporary folder 109 at a local drive 128 (e.g., a SATA-type solid-state hard drive and/or any other suitable drive-type) of the client device 116. The system 100 may cause the file hosting platform 102 to locate content data for the temporary file 111 within the cloud database 104, depending on where the folders are located. Accordingly, as illustrated, an instance of the temporary file 111 that is stored at the cloud database 104 can be “hydrated” with the content data. Example file hosting platforms 102 include, but are not limited to, DROPBOX, GOOGLE DRIVE, AMAZON DRIVE, and/or MICROSOFT ONEDRIVE.

In some embodiments, the file hosting platform 102 may include a directory structure 106 for storing data associated with one or more files or folders 110 within the cloud database 104. As used herein, the term “directory structure” may refer generally to any scheme with which a file system may cause files to be displayed to a user. An example directory structure includes, but is not limited to, an electronic folder structure. In the specific embodiment of FIG. 1A, the directory structure 106 may include one or more folders 108 at which one or more files or folders 110 are stored. As used herein, the term “folder” may refer to a directory defined in a hierarchical file system cataloging structure and may include references to individual ones of the one or more files 110 and/or other folders 110.

As used herein, the term “hydrated” may be used as a descriptive term to indicate that an instance of a file or folder 110 at a particular storage location (e.g., the cloud database 104, the local drive 128, etc.) has its corresponding content data 112 also stored at the particular storage location. For example, in the illustrated example, the instance of the file or folder 110 that is stored in the cloud database 104 can be described as a hydrated file or folder since its 5 MB of corresponding content data 112 is also stored within the cloud database 104.

As used herein, the term “dehydrated” may be used as a descriptive term to indicate that an instance of the file 110 at a particular storage location does not have its corresponding file content data 112 also stored at the particular location. For example, in the illustrated example, the instance of the file or folder 110 that is stored in the local drive 128 can be described as a dehydrated file or folder since if its corresponding content data is absent from the local drive 128.

An example dehydrated file may be a file or folder that is stored on the local drive 128 solely as metadata 138 so that the client device 116 can display a file-browser GUI that enables the user to perform certain actions at the client device 116 which do not require accessing content data such as, for example, viewing properties of the dehydrated file or folder, moving the dehydrated file or folder within the directory structure 106, deleting the dehydrated file or folder from the directory structure 106 which may or may not trigger hydration depending on the type of delete, or any other operations that may be performed without accessing content data 112. When the user attempts to open a particular dehydrated file, the system 100 may automatically fetch corresponding content data 112 from the cloud database 104. Stated alternatively, a dehydrated file or folder may remain “dehydrated” at the client device 116 (e.g., to save local storage space) until a user requests access to the dehydrated file or folder (e.g., by double clicking a file icon to open the dehydrated file) at which time, in some embodiments, the dehydrated file may be automatically “hydrated” on demand by downloading its content data. In this way, the dehydrated files do not take up substantial space on the client device 116 because the size of a dehydrated file may be limited to its corresponding metadata footprint.

In some embodiments, the client device 116 may include a user application 118 that provides access to the one or more files 110 in accordance with the directory structure 106. For example, the user application 118 may cause the client device 116 to display a file-browser graphical user interface (GUI) that enables a user to navigate through the directory structure 106. As a more specific but nonlimiting example, the user application 118 may cause the client device to display graphical folder representations for individual ones of the folders 108 and may further display file icons within the graphical folder representations to enable the user to view the status of a file, and in some embodiments, to open, move, delete, or copy files contained within the folders 108.

In some embodiments, the user application 118 may communicate with one or more components of an operating system (OS) 120 for the purpose of displaying the file-browser GUI and/or for facilitating the generation of selection data that indicates a file or folder 110 and a destination path within the directory structure 106 to copy or move the file or folder 110 to. The OS 120 may be any suitable system software for managing computer hardware and/or software resources and for providing services to the user application 118 and/or other applications (not shown). An example OS 120 may include, but is not limited to, various versions of MICROSOFT WINDOWS (e.g., WINDOWS 10, etc.) and/or various versions of macOS.

In some examples, the user application 118 may communicate with a file manager 124 of the OS 120. Example file managers include, but are not limited to, the FILE EXPLORER component of MICROSOFT WINDOWS and/or the FINDER component of the family of MACINTOSH operating systems developed by APPLE, INC. In some examples, the user application 118 may communicate with a copy/move application programming interface (API) 122 of the OS 120. The copy API 122 may be an abstraction of a data reading functionality that causes the client device 116 to read data from a specified file or folder and a data writing functionality that causes the client device 116 to write data to a specified destination path. In some embodiments, a move may be implemented as a reparent. Example user applications 118 include, but are not limited to, desktop client applications that are specifically configured to communicate with the file hosting platform 102 (e.g., the DROPBOX APP desktop application developed by DROPBOX, and/or, the ONEDRIVE desktop client). Accordingly, it can be appreciated that in various implementations the user application 118 may be configured to maintain a local instance of the directory structure 106 and to enable the user to browse through the local instance of the directory structure 106 without continuously communicating with the file hosting platform 102.

In some implementations, the client device 116 may include a synchronization engine 126 for synchronizing the local instance of the directory structure 106 that resides at the client device 116 with a cloud instance of the directory structure 106 that resides on the cloud database 104. Example synchronization engines 126 include, but are not limited to, SYNCHRONIZATION API developed by DROPBOX, BACKUP AND SYNCHRONIZATION developed by GOOGLE, and the ONEDRIVE sync engine. Accordingly, it can be appreciated that the synchronization engine 126 may be a native component of the OS 120 or may be an add-on component that is downloaded and installed onto the client device 116 separate from the OS 120.

In various implementations, the synchronization engine 126 is configured to provide access to at least some files or folders 110 stored in the cloud database 104 without downloading the content data corresponding to these files or folders to the local drive 128. For example, the synchronization engine 126 may maintain a local directory structure (e.g., an instance of the directory structure 106 that resides on the client device 116) that includes a set of dehydrated files or folders associated with first content data that is absent from the local drive 128. In such an example, a cloud directory structure (e.g., an instance of the directory structure 106 that resides on the file hosting platform 102) may include hydrated counterparts for individual dehydrated files of the set of dehydrated files. Accordingly, a user may be able to see icons and/or other data associated with dehydrated files or folders in the file-browser GUI just like any other file or folder stored on the client device 116. In some implementations, when a user instructs the OS 120 to open a particular dehydrated file, the synchronization engine 126 automatically downloads the content data that corresponds to the particular dehydrated file or folder. For example, upon a user instructing the OS 120 to open the “dehydrated” instance of the file 110 stored on the local drive 128, the synchronization engine 126 may automatically begin communicating with the file hosting platform 102 to download the 5 MB of content data 112 that corresponds to the file 110.

As further illustrated, the client device 116 includes a central processing unit (“CPU”) 130 that is connected, via a bus (not shown), to various components such as the local drive 128, a memory 132, an input/output (I/O) controller 134, and/or a network interface 136. It can be appreciated that the system components described herein (e.g., the user application 118, the OS 120, and/or the synchronization engine 126) may, when loaded into the CPU 130 and executed, transform the CPU 130 and the overall client device 116 from a general-purpose computing system into a special-purpose computing system customized to facilitate the functionality presented herein. The CPU 130 may be constructed from any number of transistors or other discrete circuit elements, which may individually or collectively assume any number of states. More specifically, the CPU 130 may operate as a finite-state machine, in response to executable instructions contained within the software modules disclosed herein. These computer-executable instructions may transform the CPU 130 by specifying how the CPU 130 transitions between states, thereby transforming the transistors or other discrete hardware elements constituting the CPU 130.

The local drive 128 and associated computer-readable media provide non-volatile storage for the client device 116. Although the description of computer-readable media contained herein refers to a mass storage device, such as a solid-state drive and/or a hard disk, it should be appreciated by those skilled in the art that computer-readable media can be any available computer storage media or communication media that can be accessed by a computing architecture such as, for example, the system 100. Communication media includes computer-readable instructions, data structures, program modules, and/or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above are also included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the client device 116. For purposes of the claims, the phrase “computer storage medium,” “computer-readable storage medium,” and variations thereof, does not include waves, signals, and/or other transitory and/or intangible communication media, per se.

The I/O controller 134 may receive and process input from a number of other devices, including a keyboard, mouse, or electronic stylus (not shown in FIG. 1). Similarly, the I/O controller 134 may provide output to a display screen (e.g., to display the file-browser GUI described herein), a printer, or other type of output device (also not shown in FIG. 1). The network interface 136 may enable the client device 116 to connect to one or more network(s) 114 such as a local area network (LAN), a wide area network (WAN), a wireless local area network (WLAN), or any other suitable network for passing information between the client device 116 and the file hosting platform 102 over a connection 140.

Referring to FIG. 1B, an example file-browser GUI 300 is illustrated that can be displayed at the client device 116 in association with the user application 118 to enable a user to enter commands for file or folder operations within the directory structure 106.

In some embodiments, the file-browser GUI 300 may be configured to graphically indicate a status for file or folder 110. In the illustrated example, the file-browser GUI 300 is graphically representing files or folders within the first folder 108(1) along with an indication of a status for each of these two files or folders.

Referring to FIG. 1B, illustrated is an example where the user is performing a double-click on the icon representing file 111 in folder 109 to open file 111. Based on the open command, the user application 118 generates selection data that indicates the file 111 should be opened. As further illustrated, the client device 116 may generate the open instruction 207 based on the selection data and, ultimately, may transmit at least some aspects of the open instruction 207 to the file hosting platform 102 in accordance with the techniques described herein. In the illustrated example, the file-browser GUI 300 is graphically representing file 111 or folder 109.

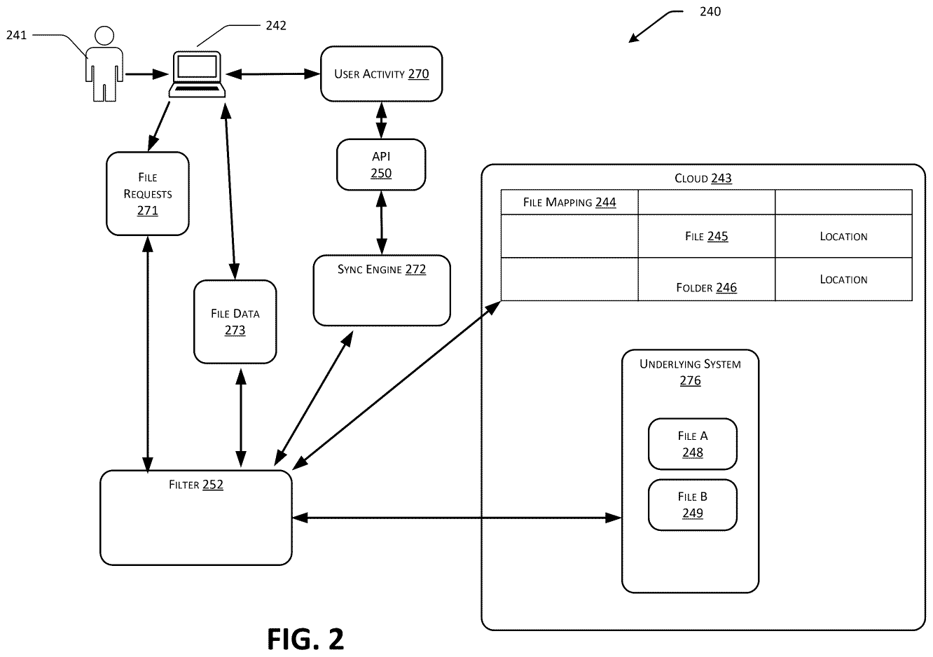

With reference to FIG. 2, a file system framework 240 is implemented for implementing a file system. Information is received indicating one or more files 248, 249 that are associated with a context of user activity 270 of a user 241. In an embodiment, the information is received via API 250. Based on the information, a temporary placeholder folder 246 and placeholder files 245 are generated corresponding to the one or more files 248, 249. In an embodiment, a characteristic of the temporary placeholder folder is indicative of the context of the user's computing activity. In one example, the characteristic is the name of the temporary placeholder folder. The name of the temporary placeholder folder can be intelligently determined using AI/ML or an algorithm. For example, the name can be based on a common denominator of the files that are associated with the context (e.g., “ProjectX”)

In an embodiment, the placeholder files are selected based on a threshold relevance to the context of the user's computing activity. The threshold can pertain to a value indicating the relevance of a file to the context, which can be based on content, the number of times accessed by the user in relation to the context, the name of the file, and the like. In an embodiment, the temporary placeholder folder and placeholder files are abstracted from underlying storage locations, which can be located in a distributed computing system.

The temporary placeholder folder 246 and placeholder files 245 are rendered on a user interface 242 indicating the placeholder folder 246 and placeholder files 245 as folders and files within the file system. In some embodiments, the placeholder files 245 are dehydrated. A mapping 244 is generated of the placeholder files 245 to underlying files 248, 249 represented by the placeholder files 245 and their storage locations. In an embodiment, the mapping 244 may be maintained in the cloud platform 243. The underlying files 248, 249 can be on an underlying system 276.

A filter 252 can be run that is configured to intercept requests 271 to access the placeholder files 245 that requires a hydration of a selected placeholder file 245 when selected via the temporary placeholder folder on the user interface. The filter 252 can cause hydration of the selected placeholder file from its corresponding underlying location and send corresponding file data 273 for rendering on the user interface 242. The filter 252 can also be configured to synchronize changes made to the selected and retrieved placeholder file with its corresponding underlying storage location represented by the retrieved file. In some implementations, a synchronization engine 272 can be run to facilitate file synchronization activities.

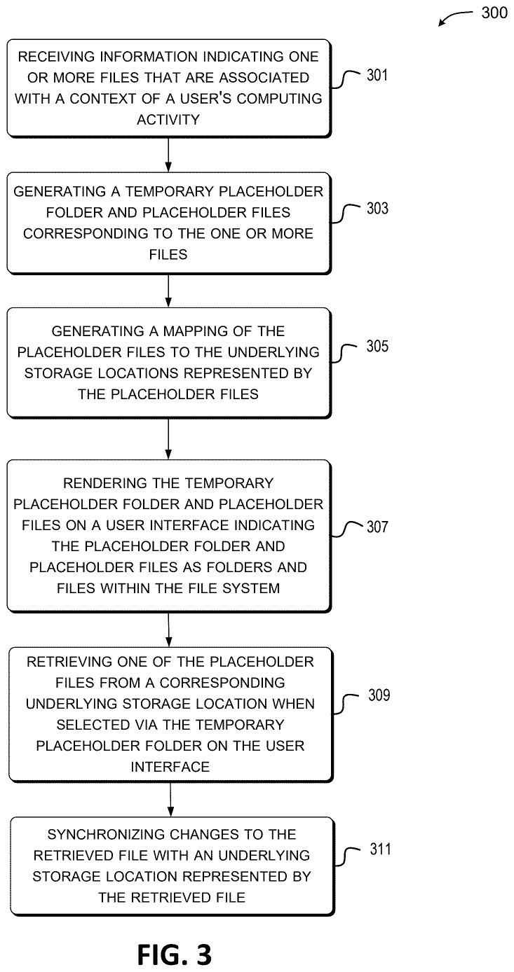

Turning now to FIG. 3, illustrated is an example operational procedure for implementing temporary file directories in a file system for managing data in a distributed computing system. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It should also be understood that the illustrated methods can end at any time and need not be performed in their entireties. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like. Although the example routine described below is operating on a computing device, it can be appreciated that this routine can be performed on any computing system which may include a number of computers working in concert to perform the operations disclosed herein.

Thus, it should be appreciated that the logical operations described herein are implemented (1) as a sequence of computer implemented acts or program modules running on a computing system such as those described herein and/or (2) as interconnected machine logic circuits or circuit modules within the computing system. The implementation is a matter of choice dependent on the performance and other requirements of the computing system. Accordingly, the logical operations may be implemented in software, in firmware, in special purpose digital logic, and any combination thereof.

Referring to FIG. 3, operation 301 illustrates receiving information indicating one or more files that are associated with a context of a user's computing activity in the distributed computing system.

Operation 303 illustrates based on the information, generating, on the file system, a temporary placeholder folder and placeholder files corresponding to the one or more files. In an embodiment, a characteristic of the temporary placeholder folder is indicative of the context of the user's computing activity. In an embodiment, the placeholder files are selected based on a threshold relevance to the context of the user's computing activity. In an embodiment, the temporary placeholder folder and placeholder files are abstracted from underlying storage locations in the distributed computing system.

Operation 305 illustrates generating a mapping of the placeholder files to the underlying storage locations represented by the placeholder files.

Operation 307 illustrates rendering the temporary placeholder folder and placeholder files on a user interface indicating the placeholder folder and placeholder files as folders and files within the file system. In an embodiment, the placeholder files are dehydrated in the temporary placeholder folder.

Operation 309 illustrates based on the mapping, retrieving one of the placeholder files from a corresponding underlying storage location when selected via the temporary placeholder folder on the user interface.

Operation 311 illustrates based on the mapping, synchronizing changes to the retrieved file with an underlying storage location represented by the retrieved file.

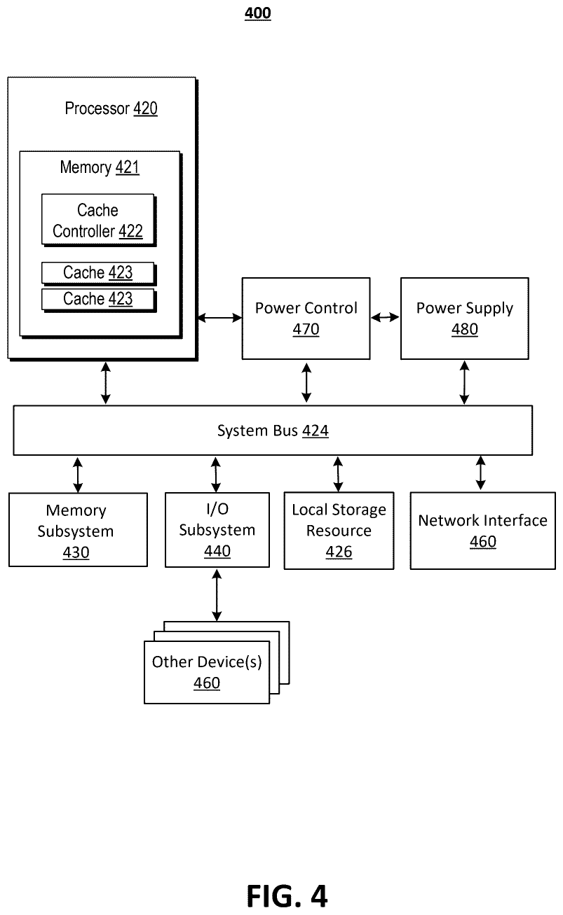

FIG. 4 illustrates a block diagram depicting selected elements of an embodiment of a computing environment 400. As described herein, computing environment 400 may represent a computing device such as a personal computer system, a desktop computer, a server, etc. As shown in FIG. 4, components of computing environment 400 may include, but are not limited to, processor subsystem 420, which may comprise one or more processors, and system bus 424 that communicatively couples various system components to processor subsystem 420 including, for example, a memory subsystem 430, an I/O subsystem 440, local storage resource 426, and a network interface 460. System bus 424 may represent a variety of suitable types of bus structures, e.g., a memory bus, a peripheral bus, or a local bus using various bus architectures in selected embodiments. For example, such architectures may include, but are not limited to, Micro Channel Architecture (MCA) bus, Industry Standard Architecture (ISA) bus, Enhanced ISA (EISA) bus, Peripheral Component Interconnect (PCI) bus, PCI-Express bus, HyperTransport (HT) bus, and Video Electronics Standards Association (VESA) local bus.

In FIG. 4, network interface 460 may be a suitable system, apparatus, or device operable to serve as an interface between computing environment 400 and a network (not shown in FIG. 4). Network interface 460 may enable computing environment 400 to communicate over the network using a suitable transmission protocol and/or standard, including, but not limited to, transmission protocols and/or standards. In some embodiments, network interface 460 may be communicatively coupled via the network to a network storage resource (not shown). The network coupled to network interface 460 may be implemented as, or may be a part of, a storage area network (SAN), personal area network (PAN), local area network (LAN), a metropolitan area network (MAN), a wide area network (WAN), a wireless local area network (WLAN), a virtual private network (VPN), an intranet, the Internet or another appropriate architecture or system that facilitates the communication of signals, data and/or messages (generally referred to as data). The network coupled to network interface 460 may transmit data using a desired storage and/or communication protocol, including, but not limited to, Fibre Channel, Frame Relay, Asynchronous Transfer Mode (ATM), Internet protocol (IP), other packet-based protocol, small computer system interface (SCSI), Internet SCSI (iSCSI), Serial Attached SCSI (SAS) or another transport that operates with the SCSI protocol, advanced technology attachment (ATA), serial ATA (SATA), advanced technology attachment packet interface (ATAPI), serial storage architecture (SSA), integrated drive electronics (IDE), and/or any combination thereof. The network coupled to network interface 460 and/or various components associated therewith may be implemented using hardware, software, or any combination thereof.

As depicted in FIG. 4, processor subsystem 420 may comprise a system, device, or apparatus operable to interpret and/or execute program instructions and/or process data, and may include a microprocessor, microcontroller, digital signal processor (DSP), application specific integrated circuit (ASIC), or another digital or analog circuitry configured to interpret and/or execute program instructions and/or process data. In some embodiments, processor subsystem 420 may interpret and/or execute program instructions and/or process data stored locally (e.g., in memory subsystem 430). In the same or alternative embodiments, processor subsystem 420 may interpret and/or execute program instructions and/or process data stored remotely (e.g., in a network storage resource, not shown).

As illustrated in FIG. 4, a memory subsystem 421 within processor subsystem 420 may include multiple data caches. A cache controller 422 within memory subsystem 421 may include circuitry to manage the contents of one or more caches 423. For example, cache controller 422 may include circuitry to determine when and if an individual cache line or a group of cache lines should be evicted from one of the caches in accordance with a policy. In at least some embodiments, cache controller 422 may also include circuitry to limit the amount of modified (dirty) cached data that would be flushed to persistent memory upon a system power failure or other power loss event, in response to requests and commands, or other events.

In FIG. 4, memory subsystem 430 may comprise a system, device, or apparatus operable to retain and/or retrieve program instructions and/or data for a period of time (e.g., computer-readable media). Memory subsystem 430 may comprise random access memory (RAM), electrically erasable programmable read-only memory (EEPROM), a PCMCIA card, flash memory, magnetic storage, opto-magnetic storage, and/or a suitable selection and/or array of volatile or non-volatile memory that retains data after power to its associated information handling system, such as system 400, is powered down. Local storage resource 440 may comprise computer-readable media (e.g., hard disk drive, floppy disk drive, CD-ROM, and/or other type of rotating storage media, flash memory, EEPROM, and/or another type of solid state storage media) and may be generally operable to store instructions and/or data. Each of the processes, methods and algorithms described herein may be embodied in, and fully or partially automated by, code modules executed by one or more computers or computer processors as depicted in FIG. 4. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage. For purposes of the claims, the phrase “computer storage medium,” “computer-readable storage medium,” and variations thereof, does not include waves, signals, and/or other transitory and/or intangible communication media, per se.

In computing environment 400, I/O subsystem 440 may comprise a system, device, or apparatus generally operable to receive and/or transmit data to/from/within computing environment 400. I/O subsystem 440 may represent, for example, a variety of communication interfaces, graphics interfaces, video interfaces, user input interfaces, and/or peripheral interfaces. As shown, I/O subsystem 440 may further communicate with various I/O devices such as a touch panel and display adapter.

As illustrated in FIG. 4, computing environment 400 may include one or more power control modules 470 and one or more power supply units (PSUs) 480. In at least some embodiments, power control modules 470 may include power distribution circuitry. In at least some embodiments, power control module(s) 470 may control the allocation of power generated by one or more of the power supply units (PSUs) 480 to other resources in computing environment 400. In some embodiments, one or more of the power control modules 470 may include a management controller (MC).

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

The disclosure presented herein also encompasses the subject matter set forth in the following clauses:
Clause 1: A computer-implemented method for implementing temporary file directories in a file system for managing data in a distributed computing system, the method comprising:
receiving information indicating one or more files that are associated with a context of a user's computing activity in the distributed computing system;
based on the information, generating, on the file system, a temporary placeholder folder and placeholder files corresponding to the one or more files, wherein a characteristic of the temporary placeholder folder is indicative of the context of the user's computing activity, the placeholder files are selected based on a threshold relevance to the context of the user's computing activity, and the temporary placeholder folder and placeholder files are abstracted from underlying storage locations in the distributed computing system;
generating a mapping of the placeholder files to the underlying storage locations represented by the placeholder files;
rendering the temporary placeholder folder and placeholder files on a user interface indicating the placeholder folder and placeholder files as folders and files within the file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

Clause 2: The computer-implemented method of clause 1, further comprising:
running a filter configured to intercept requests to access the placeholder files that requires a hydration of a selected placeholder file; and
hydrating the selected placeholder file from its corresponding underlying location.

Clause 3: The computer-implemented method of any of clauses 1-2, wherein the filter is configured to synchronize placeholder files with its corresponding underlying files.

Clause 4: The computer-implemented method of any of clauses 1-3, wherein the information is received via an API.

Clause 5: The computer-implemented method of any of clauses 1-4, wherein the context comprises a topic associated with the user's activity.

Clause 6: The computer-implemented method of any of clauses 1-5, wherein the context comprises files accessed by the user during a predefined time period.

Clause 7: The computer-implemented method of clauses 1-6, further comprising periodically removing previously generated temporary placeholder folder and placeholder files that are no longer in use.

Clause 8: The computer-implemented method of clauses 1-7, wherein settings for when and how the temporary placeholder folder and placeholder files are generated are configurable by the user.

Clause 9: The computer-implemented method of clauses 1-8, wherein the settings include one or more of: whether to generate the temporary placeholder folder and placeholder files, when to generate the temporary placeholder folder and placeholder files, and how long to maintain the temporary placeholder folder and placeholder files.

Clause 10: A device comprising:
one or more processors;
a memory in communication with the one or more processors, the memory having computer-readable instructions stored thereupon which, when executed by the one or more processors, cause the device to:
receive information indicating one or more files that are associated with a context of a user's computing activity;
based on the information, generating, on the a system, a temporary placeholder folder and placeholder files corresponding to the one or more files, wherein a characteristic of the temporary placeholder folder is indicative of the context of the user's computing activity, the placeholder files are selected based on a threshold relevance to the context of the user's computing activity, and the temporary placeholder folder and placeholder files are abstracted from underlying storage locations of the one or more files;
generating a mapping of the placeholder files to the underlying storage locations represented by the placeholder files;
rendering the temporary placeholder folder and placeholder files on a user interface indicating the placeholder folder and placeholder files as folders and files within the file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

Clause 11: The computing system of clause 10, wherein the device is further caused to:
run a filter configured to intercept requests to access the placeholder files that requires a hydration of a selected placeholder file; and
hydrate, on the device, the selected placeholder file from its corresponding underlying location.

Clause 12: The computing system of any of clauses 10 and 11, wherein the filter is further configured to:
synchronize changes made to the selected placeholder file with its corresponding underlying file.

Clause 13: The computing system of any of clauses 10-12, wherein the information is received via an API.

Clause 14: The computing system of any of clauses 10-13, wherein the context comprises a topic associated with activity of the user.

Clause 15: The computing system of any of clauses 10-14, wherein the context comprises files accessed by the user during a predefined time period.

Clause 16: The computing system of any of clauses 10-15, wherein the device is further caused to:
periodically remove previously generated temporary placeholder folder and placeholder files that are no longer in use.

Clause 17: The computing system of any of clauses 10-16, wherein settings for when and how the temporary placeholder folder and placeholder files are generated are configurable by the user.

Clause 18: The computing system of any of clauses 10-17, wherein the settings include one or more of: whether to generate the temporary placeholder folder and placeholder files, when to generate the temporary placeholder folder and placeholder files, and how long to maintain the temporary placeholder folder and placeholder files.

Clause 19: A computer-readable storage medium comprising instructions that, when executed by a computing device, cause the computing device to perform operations comprising:
receive information indicating one or more files that are associated with a context of a user's computing activity;
based on the information, generating, on the a system, a temporary placeholder folder and placeholder files corresponding to the one or more files, wherein a characteristic of the temporary placeholder folder is indicative of the context of the user's computing activity, the placeholder files are selected based on a threshold relevance to the context of the user's computing activity, and the temporary placeholder folder and placeholder files are abstracted from underlying storage locations of the one or more files;
generating a mapping of the placeholder files to the underlying storage locations represented by the placeholder files;
rendering the temporary placeholder folder and placeholder files on a user interface indicating the placeholder folder and placeholder files as folders and files within a file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

Clause 20: The computer-readable storage medium of clause 19, wherein settings for when and how the temporary placeholder folder and placeholder files are generated are configurable by the user; and wherein the settings include one or more of: whether to generate the temporary placeholder folder and placeholder files, when to generate the temporary placeholder folder and placeholder files, and how long to maintain the temporary placeholder folder and placeholder files.

1. A computer-implemented method for implementing temporary file directories in a file system for managing data in a distributed computing system, the method comprising:
receiving information indicating one or more files that are associated with a context indicative of a user's computing activity in the distributed computing system;
based on the information, generating, on the file system, a temporary placeholder folder and placeholder files corresponding to the one or more files, wherein a characteristic of the temporary placeholder folder is indicative of the context indicative of the user's computing activity, the placeholder files are selected based on a threshold relevance to the context indicative of the user's computing activity, and the temporary placeholder folder and placeholder files are abstracted from and independent of underlying storage locations and a file system hierarchy of the distributed computing system;
generating a mapping of the placeholder files to the underlying storage locations represented by the placeholder files;
rendering the temporary placeholder folder and placeholder files on a user interface indicating the placeholder folder and placeholder files as folders and files within the file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

2. The computer-implemented method of claim 1, further comprising:
running a filter configured to intercept requests to access the placeholder files that requires a hydration of a selected placeholder file; and
hydrating the selected placeholder file from its corresponding underlying location.

3. The computer-implemented method of claim 2, wherein the filter is configured to synchronize placeholder files with its corresponding underlying files.

4. The computer-implemented method of claim 1, wherein the information is received via an API.

5. The computer-implemented method of claim 1, wherein the context comprises a topic associated with the user's activity.

6. The computer-implemented method of claim 1, wherein the context comprises files accessed by the user during a predefined time period.

7. The computer-implemented method of claim 1, further comprising periodically removing previously generated temporary placeholder folder and placeholder files that are no longer in use.

8. The computer-implemented method of claim 1, wherein settings for when and how the temporary placeholder folder and placeholder files are generated are configurable by the user.

9. The computer-implemented method of claim 8, wherein the settings include one or more of: whether to generate the temporary placeholder folder and placeholder files, when to generate the temporary placeholder folder and placeholder files, and how long to maintain the temporary placeholder folder and placeholder files.

10. A device comprising:
one or more processors;
a memory in communication with the one or more processors, the memory having computer-readable instructions stored thereupon which, when executed by the one or more processors, cause the device to:
receive information indicating one or more files that are associated with a context indicative of a user's computing activity;
based on the information, generating, on the a system, a temporary placeholder folder and placeholder files corresponding to the one or more files, wherein a characteristic of the temporary placeholder folder is indicative of the context indicative of the user's computing activity, the placeholder files are selected based on a threshold relevance to the context indicative of the user's computing activity, and the temporary placeholder folder and placeholder files are abstracted from and independent of underlying storage locations and a file system hierarchy of the one or more files;
generating a mapping of the placeholder files to the underlying storage locations represented by the placeholder files;
rendering the temporary placeholder folder and placeholder files on a user interface indicating the placeholder folder and placeholder files as folders and files within a file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

11. The device of claim 10, wherein the device is further caused to:
run a filter configured to intercept requests to access the placeholder files that requires a hydration of a selected placeholder file; and
hydrate, on the device, the selected placeholder file from its corresponding underlying location.

12. The device of claim 11, wherein the filter is further configured to:
synchronize changes made to the selected placeholder file with its corresponding underlying file.

13. The device of claim 10, wherein the information is received via an API.

14. The device of claim 10, wherein the context comprises a topic associated with activity of the user.

15. The device of claim 10, wherein the context comprises files accessed by the user during a predefined time period.

16. The device of claim 10, wherein the device is further caused to:
periodically remove previously generated temporary placeholder folder and placeholder files that are no longer in use.

17. The device of claim 10, wherein settings for when and how the temporary placeholder folder and placeholder files are generated are configurable by the user.

18. The device of claim 17, wherein the settings include one or more of: whether to generate the temporary placeholder folder and placeholder files, when to generate the temporary placeholder folder and placeholder files, and how long to maintain the temporary placeholder folder and placeholder files.

19. A computer-readable storage medium comprising instructions that, when executed by a computing device, cause the computing device to perform operations comprising:
receive information indicating one or more files that are associated with a context indicative of a user's computing activity;
based on the information, generating, on the a system, a temporary placeholder folder and placeholder files corresponding to the one or more files, wherein a characteristic of the temporary placeholder folder is indicative of the context indicative of the user's computing activity, the placeholder files are selected based on a threshold relevance to the context indicative of the user's computing activity, and the temporary placeholder folder and placeholder files are abstracted from and independent of underlying storage locations and a file system hierarchy of the one or more files;
generating a mapping of the placeholder files to the underlying storage locations represented by the placeholder files;
rendering the temporary placeholder folder and placeholder files on a user interface indicating the placeholder folder and placeholder files as folders and files within a file system, wherein the placeholder files are dehydrated in the temporary placeholder folder;
based on the mapping, retrieving one of the placeholder files from a corresponding underlying storage location when selected via the temporary placeholder folder on the user interface; and
based on the mapping, synchronizing changes to the retrieved file with an underlying storage location represented by the retrieved file.

20. The computer-readable storage medium of claim 19, wherein settings for when and how the temporary placeholder folder and placeholder files are generated are configurable by the user; and wherein the settings include one or more of: whether to generate the temporary placeholder folder and placeholder files, when to generate the temporary placeholder folder and placeholder files, and how long to maintain the temporary placeholder folder and placeholder files.
